(19) United States
(12) Patent Application Publication
(10) Pub. No.: US 2025/0069014 A1
(43) Pub. Date: Feb. 27, 2025

(54) Method and System for Prioritizing Work Item Activity

(71) Applicant: David Richard Stewart, High Wycombe (GB)

(72) Inventor: David Richard Stewart, High Wycombe (GB)

(21) Appl. No.: 18/456,497

(22) Filed: Aug. 27, 2023

(51) Int. Cl. G06Q 10/0637

(52) U.S. Cl. CPC G06Q 10/0637; G06Q 10/063114; G06Q 10/06316

(57) ABSTRACT

A method and system are provided for dynamically prioritizing work activity. In an embodiment, an appropriate progression threshold period is stored for work item lifecycle statuses in work item management software. Each time a work item status is set or changed, the period is used by a computer to schedule further work activity by generating a progression threshold timestamp. When progression threshold timestamps are presented sequentially to users, work activity is closely guided across the entire lifecycle of all work items. The present invention is also an alerting system whereby work items can enter a progression alert state.

### BACKGROUND OF THE INVENTION

The present invention relates to the field of computer software used for the management of work items. Broad in scope, what will be referred to as work item management software in this discussion includes software for Information Technology Service Management (ITSM), Enterprise Service Management (ESM), Customer Relationship Management (CRM), Project Management, Product Management, and any other software that can manage work requirements, workload, jobs, or tasks of a person or enterprise team including software that combines workload management across different enterprise functions or divisions.

ServiceNow is an example of work item management software for ITSM and ESM. Salesforce is an example in CRM. Microsoft Project is an example for Project Management. Asana and Jira Service Management are examples of cross-functional work item management software.

Some work item management software systems are capable of extensive customization by customers or users of the software, where the present invention might be added by them as one or more extension to work item management software, or by means of any customization. Some other work item management software systems are not capable of extensive customization by customers or users of the software, where the present invention must be developed and introduced by the vendor software company. The present invention is applicable regardless of work item management software customizability, underlying technology, hardware configuration, or availability model including software-as-a-service (SAAS) or software installed by a work item management software customer or user.

Work item management software is often used by teams of enterprise users for the purpose of managing their daily workload. An important aspect in its use is work activity prioritization in which ideally, currently worked upon activity is the most appropriate activity for the moment in time, to meet operational or customer needs as attentively as possible.

When a work activity is carried out, it is usual for a work item, which might be a trouble ticket in ITSM, a customer service case in CRM, or a project task, to be created or updated by a user to record the work item's existence and progress, and the work item is usually given a status or state to reflect its progress.

Examples of commonly used statuses or states are new, in-progress, or on hold. All three are very broad and generic in their meaning. A more specific status or state is more meaningful and thereby more helpful in reflecting the actual lifecycle situation of the work item so that users know immediately what needs to happen next in a work item's progress towards completion.

Having meaningful snapshot insight into what needs to happen next for all work items is beneficial to how operations are overseen. For example, a meaningful on hold status might be a status that is called monitoring, and its meaning might be that work item management software users are monitoring a situation to see if, for example, an IT or product fault reoccurs. Naturally, a work item that is being monitored is of lower priority than a work item that has a status of, for example, “action required”, and so the work item that is being monitored might be given a longer period of time before a user returns to it for review and onwards progression.

Work item management software commonly allows users to add their own statuses or states and it is common for organizations to do so, especially in ITSM because IT support is quite complex in that there are many situations that a trouble ticket work item might find itself in during its lifecycle, especially in larger IT organizations. In ITSM, dozens of specific and meaningful lifecycle statuses or states are applicable to how IT organizations work. A single organization might designate and use more than twenty.

The purpose of using lifecycle statuses or states is for clarity and prioritization. The reason that organizations add their own statuses or states is to improve upon this, however despite the benefits in doing so, it is uncommon for a good or complete set of statuses or states to be established and introduced by work item management software users.

Without use of the present invention, the beneficial use of statuses and states for prioritization is limited, even if a good or full set is established, introduced, and used. The reason is that while a meaningful status or state indicates what needs to happen next with a work item, its progression is not scheduled to happen and so it might not happen in good time.

The present invention schedules all required work activities, and with timing that is chosen by an organization.

In the art of work item management software, the closest work item management software comes to achieving beneficial utility from scheduling work activity, is in ITSM.

A common type of work item is a record of a support need of an employee or business customer. New work items of this type are often progressed according to their age and sometimes work items are given a level of priority that is higher or lower than normal so that the maximum lead-time for initial response, and for completion of a work item, is systematically adjusted according to the given level of priority. A high priority work item is scheduled to be completed more quickly than those that have a normal or low priority.

In the IT sector, in ITSM, work item management software commonly includes functionality to alert users shortly before the threshold for a work item's initial response is breached. This method of alerting work item management software users is intended to attract prompt attention so that a trouble ticket with an initial response alert receives progression before the maximum lead-time for the response is passed.

Work item management software for ITSM commonly also includes functionality to alert users when the threshold for a work item's initial response is breached.

Of enterprise divisions that use work item management software to record the support needs of employees or business customers, ITSM is commonly regarded as having the most mature process for prioritizing and managing work items, but the only other ITSM standard practice methods of alerting users are shortly before the maximum lead-time for a work item to be completed, and when this second maximum lead-time, for a work item's completion, is breached.

A maximum lead-time for initial response, and for completion, is commonly referred to in ITSM as a service level target.

In ITSM, the foremost best practice framework, ITIL, includes that the performance of an IT service provider might in part be measured by how often service level targets are met and conversely, how often they breach.

Performance targets for an IT service provider might be formally substantiated in the form of a service level agreement (SLA) that refers to how often service level targets will be met. Particularly because a trouble ticket work item can be placed on hold to stop the service level target timer and so prevent the work item from breaching its completion service level target, and because trouble tickets placed on hold are difficult to manage because the service level target timer is stopped, this measure of a service provider's performance does not accurately reflect the timeliness of service provision, nor therefore does it reflect true performance. This is a substantial shortcoming and challenge for ITSM because placement of trouble tickets on hold is very often necessary and so on hold is very widely used by IT organizations. It is a shortcoming and challenge that the present invention entirely overcomes whereby SLA measurement becomes a wholly accurate reflection of true IT service provider performance.

This common ITSM implementation, of prioritization that is based on up to four alert points that are determined by a level of priority given to trouble ticket work items, is the closest comparable method of work item scheduling used for prioritizing onward progression and is useful to explain the present invention which surpasses it by prioritizing work items in a granular and different way.

Firstly, a trouble ticket initial response target and a trouble ticket completion target are both a timestamp to guide trouble ticket progression. Both can accurately be referred to as being a progression threshold timestamp. The term progression threshold timestamp is referred to often in the present discussion. In the context of the present invention, the more specific term is status progression threshold timestamp.

Secondly, both the initial response and completion targets are determined by a defined set period that can accurately be referred to as being a progression threshold period. The term progression threshold period is referred to often in the present discussion. In the context of the present invention, the more specific term is status progression threshold period.

In ITSM, a trouble ticket's level of priority that determines the periods and timestamps for response and completion is not often changed once the level of priority is specified in the first place and so both timestamps usually remain unchanged over the lifetime of a trouble ticket.

In absence of the present invention and its beneficial use, ITSM work item management software users have only these two usually static progression thresholds for guidance and alerting. Being static, and being only two, and use of on-hold, are standard practice shortcomings and constraints that are all overcome in use of the present invention.

A primary operational issue that has always existed, particularly in busy teams, is caused by this lack of guidance for the onward progression of work items. Work items often become unmanaged if not completed during the initial response, especially when on-hold is used. The result is that service needs are sometimes not met or are not met in a timely way. For work item management software teams providing support to their organization's employees or customers, the result is weak or bad service experiences that might happen quite often.

With its underlying standard practice shortcomings and constraints overcome, this operational issue is also overcome in use of the present invention.

In use of the present invention, organizations and divisions that provide support to employees or customers will not only substantially improve service experiences because support service provision will always be more responsive and timely regardless of a work item's position in its lifecycle, but for this same reason, as explained later in the present discussion, for organizations that have a service level agreement (SLA), measurement of it becomes a wholly accurate reflection of how well service is provided from the view of timeliness. This is also a capability transformation.

Two more capability transformations arise from the present invention.

Firstly, a service level agreement (SLA) that is based on how often status progression threshold timestamps breach, reflecting an organization's ability to continuously progress work items in good time, which can be expected to result in shorter work item completion times, is a better measure of performance and service provider ability than an SLA that is based only on achievement against the service level target for work items to be completed. This superior method of measuring a service provider's performance is an aspect of indirect beneficial utility gained from the present invention.

A second indirect aspect of beneficial utility is for the effective expectations management of when work items will be progressed.

With reference again to ITSM, expectations management is commonly a substantial operational need so that recipients of an IT support service know how long it is likely to be before progression or completion of their trouble ticket.

In standard practice, the only methods for communicating how long a service recipient should expect to wait for progression are firstly, the first response service level target. If the trouble ticket is not completed at that point, the only other method is communication of the completion service level target, but this is problematic because it is defunct when a ticket is placed on hold and might be too far in the future for a service recipient to be happy with. Communication of expectations that are inaccurate or unpalatable is detrimental to operations and can be expected to cause trouble ticket service recipients to chase a response from the service provider. A chased response can also be expected to happen often if no expectations for progression or completion are provided. For these reasons, trouble tickets are chased often in ITSM. In ITSM standard practice, without beneficial utility of the present invention, expectations management is a significant operational problem.

In the ITSM example, an internet browser-based service portal is typically provided for support service recipients to check the status or state of their trouble ticket, amongst other purposes. Alongside the work item's status or state, by merit of the present invention and its primary utility of work item management software users being able to deliver reliable and timely service to service recipients, a work item's status progression threshold timestamp can be presented. Also, how long remains before the progression threshold comes to pass, and awareness of when a work item has been escalated for focused review because the progression threshold has breached, which can be presented as an alert status or state in a more advanced embodiment of the present invention.

In using the present invention for accurate expectations management alongside the primary utility of reliable, timely work item progression, a service provider can expect to be effective in minimizing how often work items are chased for a response. It can be expected that the customer experience of an IT support service will be improved even further.

Customer experience and satisfaction are important outcomes for organizations, so for any service provider whether in ITSM, ESM, or CRM, beneficial utility gained from the present invention related to customer experience is substantial if not transformational.

For managed service providers that provide IT services to their business customers, the present invention brings the prospect of competitive advantages in being able to provide support services faster, more efficiently, and in a more attentive way, with service level agreements between provider and customer that are wholly meaningful because of their accuracy, and if based on status progression threshold timestamps instead of completion service level targets, because of operational relevance and specificity too. Accurate expectations management can be expected to be a competitive advantage too. Such advantages might lead to greater success in acquiring new customers and retaining existing customers. The same advantages apply to organizations that operate customer services to support their products.

For these reasons, work item management software vendors that develop work item management software, for instance ITSM software, for sale to organizations that use it, might choose to add the present invention as one or more software feature to attract more organizations to buy the software.

### SUMMARY OF THE INVENTION

In an embodiment of the present invention, each time a work item's lifecycle status or state is set or changed, whether by a user of work item management software or automatically by a workflow or by any work item management software system event procedure, a stored status progression threshold period that has been designated for the status or state is applied to generate and store a status progression threshold timestamp and so when work items are ordered and presented in sequence according to their status progression threshold timestamp, the present invention is of a system for the dynamic and appropriate prioritization of work items that adjusts to changing circumstances as each work item moves through its lifecycle.

Work activity is sequenced appropriately because each status progression threshold period is the time duration that is decided by users of work item management software, for instance by managers, as being the maximum appropriate lead-time before progression should be expected for a work item at the given status or state.

Further to the various aspects of beneficial utility already described, of reliable and timely work item progression, wholly accurate performance metrics that closely reflect actual performance, and expectations management, organizations or divisions using work item management software also benefit from flexibility of performance objectives.

As operational situations change, such as how many users are in a team, or how often and how quickly work items are being progressed before status progression threshold timestamps breach, managerial users might adjust status progression threshold periods so that, for example in ITSM or CRM, support service is provided in a faster and more responsive way, or in a slower and less responsive way, communicated as such to service recipients if the present invention is also used for expectations management.

For an ITSM or CRM managed service provider using the present invention, the timeliness of progression at various statuses or states might be agreed between provider and customer, for a highly tailored service package design and operation. The same co-creation of a service design is applicable also for internal service providers aiming to operate as well as possible.

These practical considerations in use of the present invention bring more beneficial utility to it, and there are three more worthy of mention.

Firstly, in ITSM standard practice, it is impractical and non-advantageous to combine sequencing of progression threshold timestamps for work item first response and for work item completion, into a single presented view. For this reason, especially because only these two progression points exist to guide and alert work item management software users, exacerbated by use of on-hold, leaving trouble ticket work items unguided across their mid-lifecycle, the question of which work item to work on next can be difficult to decide, particularly in working through extensive lists of work items, and so work items might often not be progressed in good time, and service level targets might, and in common practice do, often breach.

In a beneficial use of the present invention, status progression threshold timestamps are presented sequentially for all work items that are relevant to a user of work item management software, in a single view. This simplicity for users in always knowing immediately, and without need for interpretation, which work item to work on next, is another advantage over standard practice, and is another aspect of beneficial utility.

Secondly, a presented view of work items can be split logically by lifecycle statuses or states, to provide more structure to the prioritization of work items, for a more advantageous embodiment of the present invention, as illustrated in FIG. 2.

In larger teams of work item management software users, by working in this way, user roles can be assigned that are responsible for a subset of statuses and so when more than one user is assigned to a status-based role, work item cover is multiplied. Multiplied work item cover can be expanded further by some statuses that might be those that are of higher priority for progression, being aligned to more than one status-based role. This method of working with the present invention might be the most efficient approach to work item management possible because it is not necessary for work items to be assigned to a user's own queue of work items, which is standard practice but forms an almost perfectly siloed and inefficient way of working.

When conditions allow it, such as common knowledge and skills across a team, it is more advantageous to work collectively as a team in the cover and progression of work items. Alone, the present invention has beneficial utility in improving reliability and timeliness of work item progression, but in organizing teams to work in this way in use of the present invention, reliability and timeliness can be expected to improve further still.

In the present invention's basic use though, reliability and timeliness are still its strongest aspects of utility.

If for example a work item has its status changed three times during its lifetime before being completed, its progression threshold and position in a presented view of work items changes three times, moving down the list to a precise position in relation to the scheduled date and time for onward progression of all other work items as illustrated in FIG. 7.

A third further advantage and aspect of utility is that the present invention ensures that no work item is left on hold for longer than it should be.

In use of the present invention, whether a work item is on hold makes no difference to its prioritization and so nor does it make a difference to the overall reliability and timeliness of work being done by an individual or team.

This is because on-hold for a work item in work item management software is typically associated with, and thereby determined by, its lifecycle status. Some statuses are on hold, others are not.

The present invention is based on the use of statuses and states. One of two practical factors upon which the present invention relies for its beneficial utility to be realized, is continuous status management in which the status or state of a work item is changed each time it is updated to reflect progression or another change in its situation. In doing so, in teams of users adhering to continuous status management, on-hold is set and unset only when appropriate, as configured in its alignment to statuses or states used by an organization.

When an on-hold status is set, in the ITSM example, the service level target timer is stopped and conversely is restarted when a status is set that is not on hold. In use of the present invention, timely and completely appropriate toggling of on hold has the beneficial outcome of service level target measurement being wholly accurate while also being reflective of the timeliness that an organization has decided is appropriate for work items to be progressed. This is highly advantageous for IT organizations that have a service level agreement (SLA) with the organization or organizations that it supports, especially for managed services provided to paying customers. This is particularly so because without this beneficial utility achieved through use of the present invention, as previously discussed, SLA measurement is a weak measure of a service provider's performance due to its inaccuracy and imprecision.

In use of the present invention, not only can timeliness and reliability performance be expected to improve, but an organization is able to prove it to stakeholders because its measure becomes wholly accurate and aligned closely to actual performance.

The second practical factor upon which the present invention relies for its beneficial utility to be realized is for a good or full set of statuses or states to be added to work item management software reflecting the operational realities that users face.

Both practical factors are often nearly present in common practice, so for an organization to benefit from the present invention, only slight operational adjustment might be needed. This is especially so because the two practical factors are interlinked.

To adjust from occasional to continual use of statuses or states, a full or near full set of work item statuses or states needs to be available, introduced to work item management software so that one status or state will always be appropriate to summarize the current work item situation.

The other reason for continuous status management being uncommon is there being an absence of a reason to do so. The present invention introduces a strong reason to exercise continuous status management. So beneficial utility from the present invention is gained simply from using the invention alongside a good set of statuses or states.

An organization that identifies more meaningful statuses or states for its use of work item management software will gain more utility from the present invention because prioritization is more granular to specific situations that a work item finds itself in as it moves through its lifecycle. Beneficial utility is not greatly reduced if only a good subset is identified though.

There is substantial commonality in statuses and states that are applicable to all IT support organizations that use work item management software for ITSM, and to all customer service organizations that use CRM software, with some cross-over between the two. Common meaningful statuses and states are those that are most likely to be designated by an organization for use in work item management software.

For example, a customer service team that uses CRM work item management software might need to identify a CRM case as being monitored before it is completed and might sometimes or often need to ask a customer for information before the CRM case can be progressed. These two lifecycle situations always exist in ITSM too. There are close parallels between the operational needs of IT support and other customer services teams, including those teams that provide support for enterprise customers using CRM software.

In this example, without the present invention, the statuses or states might be used, but attention will not be drawn back to the work items in a timely way because onward progression is not scheduled and presented alongside the progression schedule for other work items, this being the output and outcome of the present invention.

In another example, a customer services team of an organization that, for example, develops computer software, might also sometimes need to refer a CRM case to a product development team, for instance if its software has a fault or error informed by a customer. A lifecycle status or state to reflect this situation for the CRM case might be designated for the work item management software and used by customer service teams.

In this example, without use of the present invention, even if a status or state is used to reflect the situation of the CRM case being referred to a product development team, the case might not be reapproached in a timely way not only because progression is not scheduled, but also because a product development team, that might not focus as strongly on support work as it does on product development, is responsible for the case's progression to happen.

The present invention draws timely attention back to work items. In this example, if the product development team were not to progress the case before the progression threshold period elapses, attention could be drawn back to it from the customer services team by seeing that its progression threshold timestamp is breached, and more easily if it is at a progression alert status or state, who might then chase a response from the product team. Even though the case is with another team that might not focus strongly on product support, the result can often be delivery of service and support more quickly than in the absence of the present invention, and a customer services team being more easily able to oversee progression of work items that require work from other teams.

A similar situation exists in the interplay between an IT support organization using ITSM work item management software, and a project team using project management software for work item management. Also, in the interplay between an IT support organization and a finance team, human resources (HR) team, or any other enterprise service team that might use ESM software for work item management.

The present invention is also applicable and beneficial in the use of work item management software for the management of product development or project management tasks, for instance those that contribute to the development, testing and transition of a product feature into live use, or those for an IT infrastructure project.

Tasks required of product or project management have a lifecycle, with lifecycle statuses or states that might include, for example, indication that the assignee of a work item task is stuck on the task and needs assistance from co-workers, or that input from another stakeholder is required. These statuses would benefit from having a deadline for onwards progression scheduled and closely coordinated, achieved in use of the present invention.

A more common lifecycle status or state for product or project management is to indicate that a task has moved from pending commencement to being in progress. At this point of status change, a progression threshold timestamp might be manually added specifying the task's completion target or deadline, to benefit from appropriate presented sequencing of all required work activity.

Product and project management teams often or usually use different software to CRM and ITSM teams. It is beneficial for work items for live product support to be included in the sequence of presented work item tasks that a product development team member is required to progress for product development. It is also beneficial for live project support to be included in the sequence of presented work item tasks that a project management team member is required to progress for projects. When the software used by support and product or project teams is different, for greater utility to be gained from the present invention, work item data integration between two or more work item management software systems might be required, including status progression threshold timestamp data.

In some situations, the present invention benefits from having more than one progression threshold timestamp for a single work item. For example, a manually added deadline for the completion of a project task needs to remain in place at the same time as information or assistance is sought from a co-worker or other stakeholder. Another example is in ITSM or CRM when a service recipient chases a response from the service provider. The status or state reflecting the chase might have a short progression threshold period to bring attention to the work item towards the top of a user's list of scheduled work items, but it might be decided by the user or service provider that the reason for the chase does not justify progression of the work item ahead of others. By the previous status or state remaining in place unchanged, once the chase has been processed, in an embodiment that would make obvious operational sense, the chased status or state would be removed along with its progression threshold timestamp so that scheduling for the work item returns to where it was before.

As discussed later, a manually added progression threshold timestamp is an aspect of the present invention that will often be advantageous, adding flexibility to an implementation.

In a beneficial embodiment of the present invention, progression threshold periods typically will exclude non-business hours so that progression is scheduled only during business hours. Most enterprise teams do not operate seven days a week, and twenty-four hours every day, so this aspect of the present invention is important.

All aspects of utility, whether direct or indirect, are beneficial for the experience of stakeholders, of work being delivered. The two aspects of direct utility are reliable and timely progression, and simplicity in knowing which work item to work on next. Both also benefit the employee experience of work item management software users because employees are enabled to do their job well, with relative ease.

The same applies to team managers who are also stakeholders and beneficiaries in the use of the present invention. With enterprise team members enabled to manage their work well, a manager's necessary involvement is reduced. Particularly in an embodiment in which ITSM or CRM work item silos are replaced with collective teamwork through the cover of status-based roles as described earlier, the present invention enables largely self-managing teams.

Managers might, however, still need to coordinate progression of work items that have breached their progression threshold for longer than is acceptable, to facilitate flow of activity and meeting of work item progression or completion expectations. In this use, the present invention is a system and method for managing by exception because a breached progression threshold is an exception in the timeliness and normal progression of work items.

The present invention can be referred to as a status priority system, and will be often from this point onwards, in the present discussion.

Facets and features of a status priority system are configurable status progression threshold periods, progression threshold timestamping of work items, and presentation of work items by their progression threshold timestamp, plus, in more advanced embodiments, progression alerts, and manual entry of progression threshold timestamps for statuses or states that require it.

### BRIEF DESCRIPTION OF DRAWINGS

FIG. 1 is a flow diagram of the method for prioritizing work item activity in embodiments of the present invention that includes configuration of status progression threshold periods in a status management module.

FIG. 2 is a diagram of the present invention's data presentation module in a more advantageous embodiment.

FIG. 3 is a flow diagram of the supplementary method in an advanced embodiment of the present invention for finding work items that have breached their status progression threshold, and an alert status or state stored for work items in breach of the threshold.

FIG. 4 is a diagram of the computer modules that comprise a work item management software system in an embodiment of the present invention.

FIG. 5 is a flow diagram of the method for prioritizing work item activity in embodiments of the present invention that do not include configuration of status progression threshold periods in a status management module. In embodiments of this kind, progression threshold periods are configured in one or more workflow.

FIG. 6 is a diagram of the present invention's data presentation module in a basic embodiment.

FIG. 7 is a diagram illustrating arrangement of work items on a data presentation module, sequenced for prioritization and progression according to each work item's progression threshold timestamp.

### DETAILED DESCRIPTION OF THE INVENTION

### Detailed Description of the Drawings

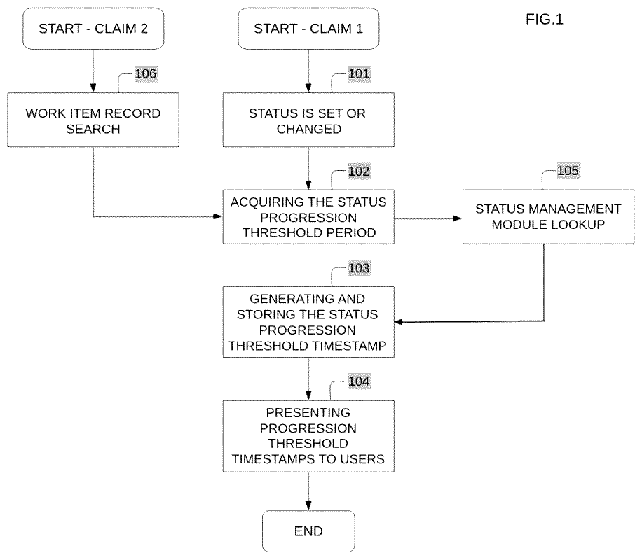

FIG. 1 is a flow diagram of the method for prioritizing work item activity in embodiments of the present invention in which work item management software users configure status progression threshold periods in a status management module 105. Work item management software might have a user interface for users to configure statuses and states, or progression threshold periods might be configured using a command line interface.

The flow diagram shows two alternative start points, one relating to claim 1 and the other to claim 2 of the present invention.

From 101 being the start point for claim 1, when a work item's lifecycle status or state is set or changed, which might be from a user action or automated in response to a system event such as a work item receiving an update, a computer, via the processor and as part of a workflow, acquires the progression threshold period 102 that has been configured for the status or state in the status management module 105 and uses it to generate and store a progression threshold timestamp 103 which is presented to users on a data presentation module 104.

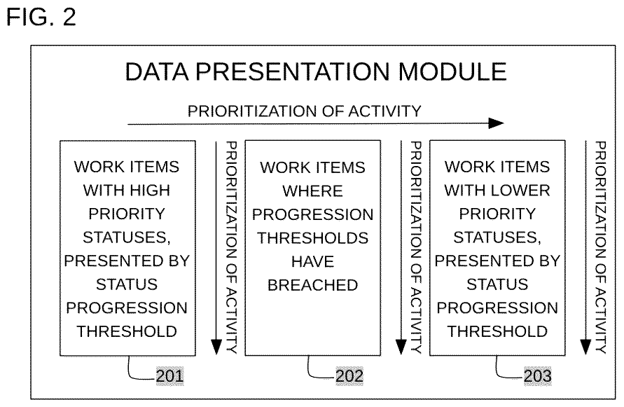

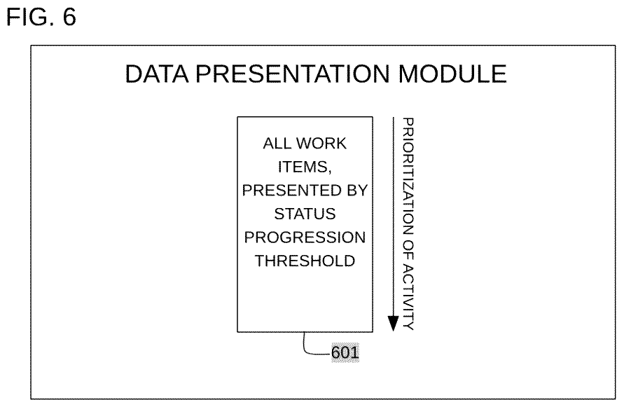

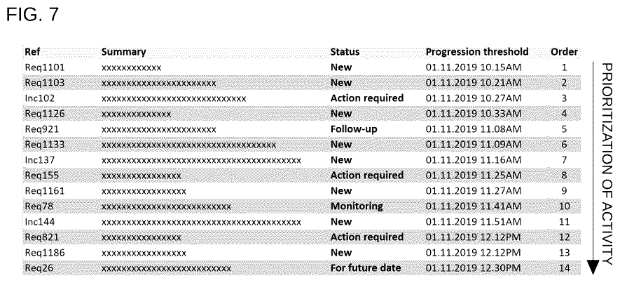

A data presentation module might be any kind of user interface including a data entry form that is part of a work item management module 401, a module that lists work items matching a work item search FIG. 2, FIG. 6, and FIG. 7, or a report.

The presentation of one or more work item 104 might not immediately follow generation and storage of the progression threshold timestamp 103, but rather might be presented on demand by a user at any time. Similarly, in use of the present invention, presentation of a progression threshold timestamp 104 might not happen before a work item's status or state is changed again, and so an implementation of the invention does not require presentation 104 every time a progression threshold timestamp is generated and stored. The same is true of any embodiment.

From 106 being the start point for claim 2, work items are searched either on demand by a user or in response to a work item management software system event such as a scheduled task or another automated process, and upon this event, a computer, via the processor, acquires 102 by lookup in the status management module 105 the status progression threshold period for the status or state of each work item that is found by the search and uses each progression threshold period to generate and store a progression threshold timestamp 103 for each work item found by the search, presented, ideally sequentially, on a data presentation module 104.

Practical examples of this embodiment, from start point 106 corresponding with claim 2, are the opening by a user of a module that is a search list listing work items matching a work item search, or a module that is a report, or a module that is a data entry form that is part of a work item management module 401. In these examples, the module that is opened by a user to search work items is a data presentation module 104.

Acquiring a progression threshold period to generate and store a progression threshold timestamp can be through any computational means that forms part of a workflow, for instance a business rule, event procedure, or an application programming interface (API) that encapsulates workflow steps.

FIG. 2 is a diagram illustrating an arrangement of a search list data presentation module in a more advantageous embodiment. A user interface is configured to organize and present work items that are relevant for the attention of a user, logically grouped by lifecycle status so that each group is a level of priority for guiding work item activity and progression, with each status group ordered by status progression threshold timestamps 201 and 203.

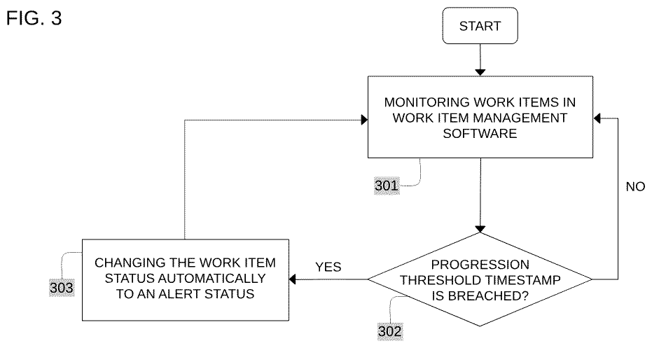

Also illustrated is the combined presentation of work items that have breached their progression threshold 202. In a more advanced embodiment of the present invention that includes the supplementary method to set an alert status or state as illustrated in FIG. 3, work items that have breached their progression threshold will be at the alert status or state.

FIG. 3 is a flow diagram of the supplementary method for finding work items that have breached their progression threshold and for those that are found, setting of an alert status by changing the work item status. When monitoring of progression threshold timestamps 301 finds a work item that has a progression threshold timestamp that is in the past and is therefore breached 302, the work item's status is changed to the alert status 303.

The present invention includes that an alternative method is for a work item's primary status or state to remain the same and a separate alert status or state be set and stored for the work item. In this embodiment of the present invention, the status priority system might be configured to remove the alert status or state at the point that the work item has its primary status or state changed by a work item management software user because such user action indicates that the work item has been progressed and the work item is, in operation of the present invention, given a new progression threshold timestamp that is not in breach. Such intricacy in how the present invention is implemented would be common sense and so in a commensurate manner, does not form part of the present invention's claims.

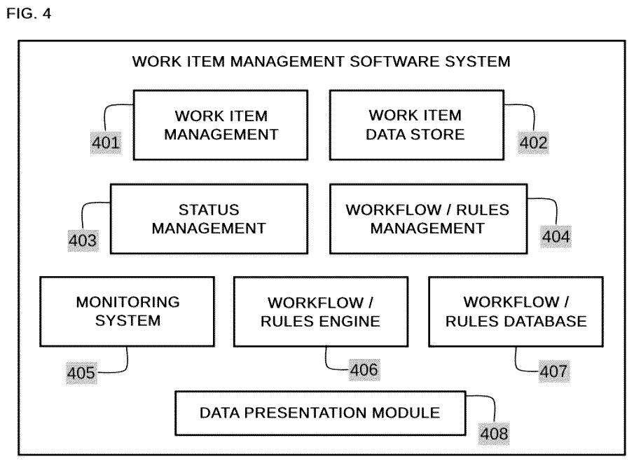

In a work item management software system, some of the component modules that are shown in FIG. 4 are used by the supplementary method for finding work items that have breached their progression threshold, and for the setting of an alert status or state. Those skilled in the art and with access to the present teachings will know how to use them to produce an alert system.

FIG. 4 is a diagram of the computer modules that are required to form a work item management software system in an embodiment of the present invention.

Work item management module 401 is one or more user interface in which work items are added, updated, and edited, with work item data stored in a work item data store 402 that might be one or more database data table.

Status management module 403 also has a data store to keep a record of work item lifecycle statuses or states that are used by work item management software users during work item management 401.

In a preferred embodiment of the present invention, the status management module 403 has user configurable status progression threshold periods that are associated with each status or state, and in a more advantageous embodiment, includes the configuration of more than one progression threshold period for each status or state corresponding with one or more other value such as a team name or a level of work item priority or a combination of values.

In a more advantageous embodiment of this kind, the status management module user interface and storage might include a default status progression threshold period for each status or state and that value might be a required value to be configured for each status. Such intricacy in the implementation of an embodiment would be obvious or common sense for someone knowledgeable and practiced in the art of work item management software.

In a more advanced embodiment that includes progression threshold breach alerts, an embodiment might include the alert status or state name specifically referenced and identified in the status management module 403. In this embodiment, the workflow, business rule or another computer processing function that is configured to monitor for breached progression threshold timestamps can look up the specifically referenced alert status or state so that it does not need to be configured by name in the workflow rules management module 404.

System workflows, business rules or other computer processing functions that are required of the present invention are added and configured in the workflow rules management module 404. This is one of up to four component modules that comprise the overall workflow module that is required of a work item management software system in an embodiment of the present invention. The other three modules are a monitoring system 405, a workflow rules engine 406, and a workflow rules database 407 in which configured workflows, business rules or other computer processing functions that are required of the present invention are stored to be found by the workflow rules engine 406 triggered by the monitoring system 405 when a system event occurs such as a lifecycle status being set or changed.

A work item management software system might bring the functionality and use of two or more component modules together into as few as one single module. Also, an embodiment of the present invention might not require one or more of the modules or its functionality. For instance, an embodiment that generates and stores progression threshold timestamps in response to a work item record search 106 and 506 might not require the monitoring system module 405. The same exclusion might exist also when work item management software has functionality to run a workflow directly through the workflow rules engine 406 upon an event such as a change of work item lifecycle status or state, thereby bypassing the need for the software to monitor for the change in work item value.

A workflow, business rule, or other computer processing function that is required of the present invention and added and configured through workflow rules management 404, might be added and configured by administrator users of work item management software, or might be added and configured by the software vendor who develops and sells the software if the software includes an implementation of the present invention. When added by the software vendor, if an administrator user does not need to make changes to an included workflow, business rule, or other computer processing function that forms part of an implementation of the present invention, an embodiment might hide it from all users, or otherwise prevent its configuration from being changed.

In a preferred embodiment in which status progression threshold periods are configured by users in the status management module 403, in an embodiment that generates and stores one or more progression threshold timestamp upon the event of a work item lifecycle status or state being set or changed 101, when the work item management software monitoring system 405 detects that a work item status or state has been set or changed, the workflow rules engine 406 runs a workflow, business rule, or another computer processing function that is required of the present invention and that has been configured in the workflow rules management module 404 and stored in the workflow rules database 407. The workflow, business rule or other processing function looks-up the status progression threshold period from the status management module 403, based on the work item's status or state and any other value parameters configured for the status or state in the status management module, and using the matching progression threshold period, generates, via a computer processor, a progression threshold timestamp that is stored in the work item data store 402.

In this preferred embodiment in which status progression threshold periods are configured by users in the status management module 403, in an embodiment that generates one or more progression threshold timestamp on demand from a user initiating work item search criteria 106, the data presentation module 408 might be configured to use a rule configured in the workflow rules management module 404 and stored in the workflow rules database 407 to lookup the status progression threshold period from the status management module 403 for each work item matching the search, based on each work item's current status and any other value parameters configured for the status in the status management module, and using the matching progression threshold period generate a progression threshold timestamp via a computer processor for each work item, presented on the data presentation module 408.

In an embodiment in which the status management module does not include configuration parameters for status progression threshold periods and so progression threshold periods are configured by users in one or more workflow, in an embodiment that sets and stores progression threshold timestamps upon the event of a work item lifecycle status or state being set or changed 501, one or more workflow is added and configured by work item management software users through the workflow rules management module 404 for the workflow rules engine 406 to find in the workflow rules database 407 when the monitoring system 405 detects that a work item status or state has been set or changed. A user-added workflow might be configured to identify parameters other than only the status or state, for instance a team name or level of work item priority, with different progression threshold periods associated with each matching criteria, configured in the workflow and used for generating, via a computer processor, a different progression threshold timestamp depending on the criteria.

All database management systems, including work item management software, have a data query engine that can find and filter matching search data from data stores such as data tables, for example to collect targeted data from a work item data store 402. In an embodiment of the present invention that generates and stores progression threshold timestamps each time a status or state is set or changed 101 and 501, when a user opens a data presentation module 408, FIG. 2, and FIG. 6, progression threshold timestamp data is obtained by the work item management software system's data query engine from the work item data store 402 alongside any other searched work item data, and is presented to the user on the data presentation module user interface.

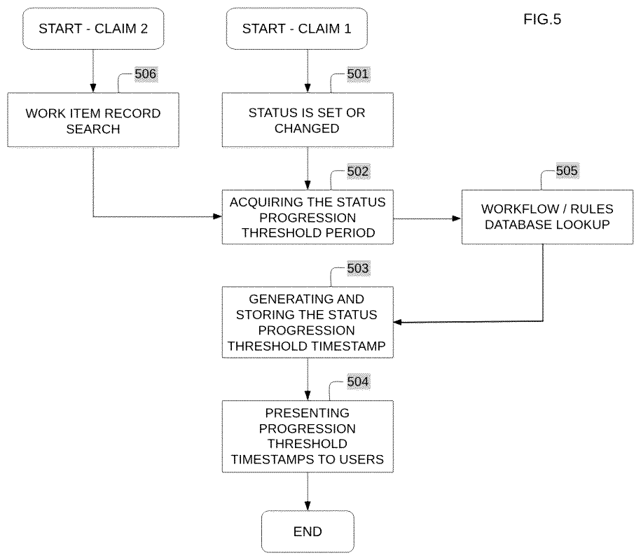

FIG. 5 is a flow diagram of the method for prioritizing work item activity in embodiments of the present invention that do not include configuration of status progression threshold periods in a status management module.

The flow diagram shows two alternative start points, one relating to claim 1 and the other to claim 2 of the present invention.

From 501 which is the start point for claim 1, when the lifecycle status or state of a work item is set or changed 501, a computer, via the processor, acquires the progression threshold period 502 that has been configured for the status or state in a workflow or business rule 505 that generates and stores a progression threshold timestamp 503 which is presented, ideally sequentially, alongside progression threshold timestamps of other work items so that users are guided appropriately from one work item activity to the next 504.

From 506 which is the start point for claim 2, when one or more work items are searched either on demand from a user, for example when a user interface is opened, or in response to a work item management software system event such as a scheduled task, a progression threshold timestamp is generated and stored for each work item in the search, in the same way as for the start point for claim 1.

Acquiring a progression threshold period to generate and store a progression threshold timestamp can be through any computational means that forms part of a workflow, for instance a business rule, event procedure, or an application programming interface API that encapsulates workflow steps.

FIG. 6 is a diagram illustrating a basic embodiment of a work item search list data presentation module in ideal use of the present invention. All work items that are relevant for the attention of a user are presented together on a user interface, sequenced for prioritization according to each work item's status progression threshold timestamp.

FIG. 7 is a diagram that shows how work items presented on a search list data presentation module FIG. 2 and FIG. 6 are, in ideal use of the present invention, sequenced for prioritization and progression according to each work item's progression threshold timestamp.

### Detailed Description of Embodiments

A workflow rules management module 404 for users of work item management software to add and configure workflows is commonly included in work item management software but often to a limited degree in scope of functionality that prevents the present invention from being added by users in a way that provides beneficial utility. In some work item management software, however, the beneficial outputs and outcomes of the present invention can be achieved by user customization of the software, by adding one or more workflow, business rule, or another computer processing function that is required of an embodiment of the present invention.

For the requirements of most organizations, beneficial utility will be gained only when non-business hours are excluded from a progression threshold period when generating a progression threshold timestamp. Workflows often or usually cannot be configured by users to do this, due to limitations in the functionality of work item management software. An alternative is for a work item management software company who develops the software, to build the present invention's functionality into their software instead.

Work item management software commonly includes a user interface module in which lifecycle statuses or states can be added, edited, and removed, and sometimes work item management software has functionality to configure statuses, for instance, particularly in ITSM, whether each status places the work item on hold. This is, in the present discussion, called the status management module 403.

In a preferred embodiment of the invention shown in FIG. 1, a status priority system can be produced by adding to a status management module 403 so that user configurable options are provided to add one or more progression threshold period for each work item lifecycle status or state, with one or more workflow configured to lookup a progression threshold period from the status management module either when a status or state is set or changed 101, or for a work item record search 106, for the generation and storage of a progression threshold timestamp that is presented on a data presentation module 408.

In an embodiment, the data presentation module 408 might be a work item management software module that existed before a status priority system is added to the software, modified with the addition of one or more element for the status priority system, for instance a data column, field, or label, for the presentation of progression threshold timestamps. In an embodiment of this kind that modifies one or more pre-existing module for the presentation of work item progression threshold timestamps, the pre-existing module is a data presentation module 408 for purposes of interpreting the present invention.

In an embodiment of the present invention that includes an alert status or state, a status priority system includes a user interface, which might be the same interface as that used for adding and editing statuses 403, to add an alert status or state.

In the art of work item management software, the alert status or state in an embodiment might be specifically configured in a workflow rule or might be identified by a workflow rule as a constant value configured in work item management software. If identified as a constant value, the user interface through which the constant value is configured, whether that be the same interface through which statuses or states are added and edited, or through another interface, forms part of the status management module 403 for purposes of interpreting the present invention.

In an embodiment that includes an alert status or state, the alert status or state can be presented to alert users, including managers, on a user interface module. In an embodiment that changes a work item's status or state to the alert status or state, one such interface module is a data presentation module 408.

In an embodiment that possesses greater utility by providing configuration options for a more precise status priority system that better fits varying operational needs, more than one progression threshold period can be configured for each status or state, with each relating to, and configured for, a constant value or combination of constant values, for instance a team name or a level of work item priority that has been added and configured in work item management software. This additional criterion is used by a workflow, business rule, or another computer processing function that is required of an embodiment of the present invention, to acquire the correct progression threshold period for a work item's specifics.

As previously discussed in the context of utilizing the present invention for product or project management, where task deadlines need to remain in place, or for handling chased trouble ticket work items in ITSM where, once the chase has been reviewed, the trouble ticket might not be progressed at that time and so the chase status and its progression threshold timestamp is removed to leave the pre-existing status or state and its timestamp intact, an embodiment of the present invention might include that more than one status or state can exist at the same time for a single work item. Those skilled in the art and with access to the present teachings will know how to produce this implementation which might include adding a configuration for statuses or states in the status management module 403 to identify those that are primary or secondary statuses or states.

In use of the present invention, in the way that teams of work item management software users ideally need to work, it is often beneficial for a work item to have its progression threshold timestamp added manually. In an embodiment that includes this capability, work item management software might be programmed or configured to prompt the user when a status set by a user is one that requires a manual progression threshold timestamp, or otherwise might simply have a data entry field for it to be specified. A manually specified progression threshold timestamp might be the date and time of an appointment, a deadline, or a reminder to return to the work item for review at a particular time.

An embodiment that includes this capability is particularly beneficial for ensuring appointments are met, because the date and time of the appointment will rise to the top of work items to be progressed as presented on a data presentation module 408 and as illustrated in FIG. 2, FIG. 6, and FIG. 7. In customer services, including in ITSM, reliably met appointments are good for customer experience of a provided support service. Closely coordinated appointments is a third aspect of direct beneficial utility gained from use of the present invention, complemented by the various indirect benefits as previously described.

Another enhancement that also improves upon the operational utility of the invention is for an embodiment to adjust the progression threshold period, or the current date and time, or a combination of the two, when generating a progression threshold timestamp.

For example, in an embodiment that includes generation of an alert status or state, it can be beneficial for an organization to have more than one progression threshold timestamp for each work item, with one being a warning timestamp that is a specific period after the progression threshold period, to alert an organization's managers that breach has been for longer than is deemed by management to be acceptable. The alert status or state might use this adjusted progression threshold timestamp instead, or as well as another alert generated when the initial progression threshold period elapses. In a similar way to producing an embodiment that can have more than one status or state for a single work item, those skilled in the art and with access to the present teachings will know how to produce a beneficial status priority system that incorporates more than one progression threshold timestamp for a single work item while keeping presentation on a data presentation module 408 clean of unwanted duplication.

An embodiment of the present invention might utilize standard but perhaps unusual features of work item management software. For example, in ITSM, work item management software for managing trouble ticket work items commonly has a module for configuring specified business hours of the team or teams that use the software, and upon which service level target measurement is based, excluding weekends, evenings and national holidays.

Work item management software for ITSM commonly also has a module for specifying service level targets for each level of trouble ticket priority, for a first response and for completion of trouble tickets. Configuration in a business hours module interacts with configuration in a service level target module so that first response and completion service level target timestamps are accurate to the hours that teams of work item management software users operate.

Work item management software might have feature functionality allowing multiple service level target profiles to be created that can each be referenced by a workflow configured in workflow rules management 404.

Work item management software might also have feature functionality for a next response progression threshold period, configured alongside those for first response and completion for levels of work item priority in a service level target profile, that can be referenced by the workflow rules engine 406 and workflow rules management 404. In work item management software that has these features, of multiple service level target profiles and configurable next response progression threshold periods that are fully integrated with the work item management software's workflow rules engine 406, or that allows administrator users to add such functionality, an embodiment of the present invention can be formed by adding a service level target profile for each work item lifecycle status or state so that when a work item's status or state is changed in one embodiment, or work items are searched in another embodiment, the next response progression threshold period stored in the corresponding service level target profile is acquired by a workflow, business rule, or another computer processing function that is required of an embodiment of the present invention, to generate and store a next response progression threshold timestamp.

In embodiments of this kind, a next response progression threshold timestamp is a status progression threshold timestamp that can be presented on a data presentation module 408, and status-based service level target profiles are an extension to the status management module 403 in interpretation of the present invention.

A progression threshold period might be in any time unit, for example a set number of seconds, minutes, hours, days, weeks, or months, or any combination of time units. As has been discussed, for effective and beneficial utility to be gained from the present invention, progression threshold periods might typically include business hours only, excluding evenings, weekends, and national holidays during which an organization or work item management using team is not operational.

Embodiments of the present invention require a computer. In the present discussion, a computer might have, as is common of all computers, a processor to process data, a computer readable temporary data storage memory, and computer readable long term or permanent data storage, often with other hardware devices that might include a computer network adapter, computer monitor, keyboard, and mouse. A computer can execute instructions of computer coded software applications, an example of which is work item management software.

A computer might be virtualized in which computer virtualization software virtualizes physical hardware resources including processor, memory, and storage, that are shared between more than one virtual computer that is built, run, and managed in the virtualization software.

A computer might be of a kind that did not commercially exist at the time of the present writings.

A computer has universal meaning, and its universal meaning shall be taken alongside this description in interpreting the present writings.

Commonly, work item management software is a computer application that uses a relational database containing a plurality of data stores, but the invention is not limited to software that uses a relational database.

In the art of relational databases, a data table might commonly be referred to as a data store and for the present discussion, the two terms are interchangeable in their meaning.

In the present discussion, the term store, and the term storing, and the term stored, refers to one or more data record or other data object that is set by being saved to a data store or held in computer memory, and refers also to one or more existing data record or data object or data within one or more data record or data object that is set by being edited, updated, or changed in any way. Store, storing and stored have universal meaning in the art of work item management software and their universal meaning shall be taken alongside this description in interpreting the present writings.

Data and data records might be stored in any media, for instance solid state disks, magnetic disks, or computer memory and might be stored permanently until edited, updated, changed, or deleted, or might be stored temporarily until a computer user no longer needs the data for current work activities of the user.

A business rule for the present discussion may be described as any criterion or set of criteria that can be used by a computer or IT system to determine when data is to be processed, and then how it is to be processed. For example, criterion might be a change of work item status when a work item is updated, and the business rule might, upon this computer event, process data to generate a progression threshold timestamp. A business rule has universal meaning in the art of work item management software and its universal meaning shall be taken alongside this description in interpreting the present writings.

A workflow for the present discussion may be described as one or more logically arranged business rules that are triggered in response to a computer system event. A workflow has universal meaning in the art of work item management software and its universal meaning shall be taken alongside this description in interpreting the present writings.

Being broadly for the same purposes in the art of work item management software systems, workflow, business rule, rule, and rules, are generally interchangeable terms in the present discussion. Where reference is made to a workflow, its meaning is of a workflow, business rule, or another computer processing function that is required of the present invention.

Reference is made in the present discussion to a search, and to work items being searched. In the art of work item management software systems, a search for data is also called a query, data query, lookup, or data lookup, all of which have the same meaning.

Reference to work item management software is made often in the present discussion however the invention might in part be embodied in a computer system connected to work item management software, for instance a data extraction and reporting tool, or another database system that reads or receives data from work item management software.

Reference to a work item is made often in the present discussion. A work item is a data record for a work task stored in work item management software, for example an incident ticket stored in ITSM software, or a case stored in CRM software, or a task stored in project management software.

The present invention can apply to work item management software of any kind, of any technical design or architecture, that is used by any enterprise or work organization sector.

An embodiment of the present invention can include more than one instance of the invention integrated together to present on a data presentation module 408 work items generated and stored in more than one work item management software system.

For the purposes of the present discussion, an enterprise may be any organization of persons, such as a business, university, government, military, and so on. The terms enterprise, business, and organization are generally interchangeable in their meaning.

User and work item management software user are interchangeable terms.

In reference to embodiments of the present invention, where reference is made to a progression threshold or progression thresholds, if the context is not clearly one or the other, this relates to either one or more status progression threshold period or one or more a status progression threshold timestamp.

In reference to embodiments of the present invention, status progression threshold and progression threshold are interchangeable terms.

Progression threshold period and progression threshold time period are interchangeable terms.

Timestamp refers to a date and time but might be presented on a data presentation module 408 as only a time.

Having similar meaning, status and state are generally interchangeable terms.

Reference to a user interface is made often. In the present discussion, a user interface for a computer display screen might be, but is not limited to be, for example, a search list of work items, a dashboard, a data entry form, a user input prompt, or a page displayed in a web browser.

In an implementation of the present invention, more than one processor may be used. Where reference is made to a computer processor, its meaning shall include where more than one processor is used.

Any suitable computer programming language might be used to produce and implement the invention, or, depending on features of work item management software, the invention might be configured without use of a programming language.

Embodiments may be implemented in a computer-readable storage medium for use by or in connection with the apparatus, system, or device. Embodiments can be implemented in the form of control logic in software or hardware or a combination of both. The control logic, when executed by one or more processors, may be operable to perform that which is described of the present invention.

For clarity, certain well-known components, such as data storage, computer memory, processors, power supplies, operating systems, and so on, have been omitted from the figures. However, those skilled in the art and with access to the present teachings will know which components are needed to produce the present invention and how to implement them to meet the needs of a given work item management software or an implementation that includes one or more other computer system connected to it.

Likewise, details of technical methods and configuration that might be used to produce aspects required of the invention, for instance data stores, and user interface modules, and data queries, have been omitted from the figures and this discussion. Those skilled in the art and with access to the present teachings will know how to produce them.

Steps shown as sequential in figures, diagrams and images can be performed at the same time.

It will also be appreciated that one or more of the elements depicted in the figures and diagrams can be implemented in a more separated or integrated manner, or even removed or rendered as inoperable in certain cases, as is useful in accordance with a particular work item management software, implementation of the invention, or use of it.

The present invention may be produced and implemented in any conceivable embodiment, not limited to those that have been included and described in the present discussion.

In general, while the present discussion has given examples of how the present invention might be produced and implemented, the functions of embodiments can be achieved by any means as is known in the art. Distributed, networked systems, components, and/or circuits can be used. Communication, or transfer, of data may be wired, wireless, or by any other means.

It will be appreciated that the claims of the present invention do not cover minor adjustments that might be made in an implementation, or any inaccuracy in how work item management software determines the date and time that a work item lifecycle status or state is set or changed, so that the implementation does not exactly correspond with the claims despite the implementation being almost identical to one or more claims. If a similar or almost identical implementation, method, apparatus, or system achieves the essential output or outputs and utility of the present invention, of presented status progression threshold timestamps and in a more advanced embodiment, of a system or method for alerting when progression threshold timestamps have breached or have breached for longer than is acceptable for users and other stakeholders of work item management software, any such adjustment or inaccuracy is within the essential scope and spirit of the present invention.

Many modifications may be made to adapt a particular situation to the essential scope and spirit.

It is also within the scope and spirit to implement a program or code that can be stored in a computer-readable medium to permit a computer to perform any of the methods described.

As used throughout the present writings, including in the claims that follow, “a”, “an”, and “the” includes plural references unless the context clearly dictates otherwise. Also, “is”, and “are” includes nondefinite meaning also, for instance “might be”, unless the context clearly dictates otherwise. Also, the meaning of “in” includes “in” and “on” unless the context clearly dictates otherwise.

What is claimed is:

1. A method for at least one computer to maintain a record of when work items should be progressed, the method comprising:
storing, from user input at a computer, a progression threshold time period for each of a plurality of work item lifecycle statuses or states corresponding to the work of an organization;
acquiring, by a computer and as part of a workflow, the progression threshold time period when a work item status or state is set or changed, and storing, by a computer, a progression threshold timestamp generated via a computer processor;
presenting progression threshold timestamps to users on a computer user interface;
wherein a progression threshold timestamp is determined as the date and time that the work item lifecycle status or state is set or changed plus its progression threshold time period plus or minus any adjustment that might be applied;
wherein a user is an agent of the organization.

2. A method for at least one computer to generate records of when work items should be progressed, the method comprising:
storing, from user input at a computer, a progression threshold time period for each of a plurality of work item lifecycle statuses or states corresponding to the work of an organization;
acquiring, by a computer, the progression threshold time period of one or more work items that correspond to search criteria, and storing, by a computer, a progression threshold timestamp generated via a computer processor for each corresponding work item;
presenting progression threshold timestamps to users on a computer user interface;
wherein a progression threshold timestamp is determined as the date and time that a work item lifecycle status or state is set or changed plus its progression threshold time period plus or minus any adjustment that might be applied;
wherein a user is an agent of the organization.

3. The method of claim 1, further comprising:
monitoring, via a computer processor, work item progression threshold timestamps to find those that are in the past;
changing the lifecycle status or state of each work item that has a progression threshold timestamp that is in the past, to a predetermined alert status or state.

4. The method of claim 3, wherein the lifecycle status or state is not changed, and an alert status or state is stored additionally for each work item that has a progression threshold timestamp that is in the past.

5. The method of claim 2, wherein the lifecycle status or state of a work item is changed to a predetermined alert status or state when its progression threshold timestamp is in the past.

6. The method of claim 5, wherein the lifecycle status or state is not changed, and an alert status or state is stored additionally for each work item that has a progression threshold timestamp that is in the past.

7. The method of claim 1 or of claim 2 wherein one or more lifecycle status or state has stored a plurality of uniquely identifiable progression threshold time periods whereby one is specifically acquired to generate and store a progression threshold timestamp.

8. The method of claim 1, wherein presented progression threshold timestamps include those that have been manually entered by users via a user interface.

9. The method of claim 1, wherein only business work hours are included in a progression threshold time period for generating a progression threshold timestamp.

10. The method of claim 2, wherein only business work hours are included in a progression threshold time period for generating a progression threshold timestamp.

11. An apparatus comprising:
at least one computer processor coupled to at least one processor-readable storage device, wherein a processor-readable storage device includes one or more instructions executable by a computer processor to perform the following acts:
store, from user input, a progression threshold time period for each of a plurality of work item lifecycle statuses or states;
generate and store progression threshold timestamps;
present progression threshold timestamps to users;
wherein a progression threshold timestamp is determined as the date and time that the lifecycle status or state of a work item is set or changed plus the progression threshold time period that is stored for the status or state plus or minus any adjustment that might be applied;
wherein a user is an agent of an organization that uses the apparatus.

12. An apparatus according to claim 11, wherein the apparatus is further caused to:
monitor work item progression threshold timestamps to find those that are in the past; and
store a predetermined alert status or state for each work item that has a progression threshold timestamp that is in the past.

13. An apparatus according to claim 11, wherein the apparatus is further caused to store, from user input, a plurality of uniquely identifiable progression threshold time periods for each lifecycle status or state whereby one is specifically acquired to generate and store a progression threshold timestamp.

14. An apparatus according to claim 11, wherein the apparatus is further caused to present progression threshold timestamps including those that are manually entered by users via a user interface.

15. An apparatus according to claim 11, wherein the apparatus is further caused to include only business work hours in a progression threshold time period.

16. A system comprising:
at least one computer processor coupled to at least one processor-readable storage device;
a status management module for storage of work item statuses or states and their progression threshold time period;
a workflow module for storage of instructions to generate progression threshold timestamps via a processor; and
storage of one or more data presentation module user interface for presenting progression threshold timestamps to users;
wherein a progression threshold timestamp is determined as the date and time that the status or state of a work item is set or changed plus the progression threshold time period stored for the work item plus or minus any adjustment that might be applied;
wherein a user is an agent of an organization that uses the system.

17. A system according to claim 16, further comprising:
an alert status or state identified in the status management module; and
a workflow to monitor work item progression threshold timestamps to find those that are in the past and for those that are found, to set the alert status or state.

18. A system according to claim 16, wherein the system includes configurable storage of a plurality of uniquely identifiable progression threshold time periods for each status or state whereby one is specifically acquired to generate and store a progression threshold timestamp.

19. A system according to claim 16, wherein the system includes presentation of progression threshold timestamps including those that are manually entered by users via a user interface.

20. A system according to claim 16, wherein the system includes only business work hours in a progression threshold time period.
